(19) United States
(12) Patent Application Publication
(10) Pub. No.: US 2022/0366687 A1
(43) Pub. Date: Nov. 17, 2022

(54) SYSTEM AND METHOD FOR DRONE LAND CONDITION SURVEILLANCE

(71) Applicant: HEIMDALL AEROSPACE LTD, Tadley (GB)

(72) Inventors: Tim O'Neill, Tadley (GB); Howard Lee, Seattle, WA (US)

(21) Appl. No.: 17/741,867

(22) Filed: May 11, 2022

Related U.S. Application Data
(60) Provisional application No. 63/187,194, filed on May 11, 2021.

(51) Int. Cl. G06V 20/17; H04N 7/18; G06V 20/52; G06T 7/20; G06T 11/00; B64C 39/02; B64D 47/00

(52) U.S. Cl. CPC G06V 20/17; H04N 7/183; G06V 20/52; G06T 7/20; G06T 11/00; B64C 39/024; B64D 47/00; G06T 2200/24; G06T 2207/30232; G06T 2207/30196; G06T 2207/10032; G08B 13/00

(57) ABSTRACT

A method for performing property surveillance via an unmanned aerial vehicle is provided. Surveillance of one or more properties via an unmanned aerial vehicle is obtained. A geofence that determines boundaries of one of the properties is created using the surveillance. Surveillance outside the geofence for the property is blurred. The blurred surveillance is provided to an owner of that property.

### FIELD

This application relates in general to surveillance, and in particular to a system and method for drone land condition surveillance.

### BACKGROUND

The use of unmanned aerial vehicles (UAV), such as drones has increased rapidly within the past decade. UAVs are unmanned aircrafts that are controlled via remote controls or computer applications. UAV are extremely useful in accessing areas that are traditionally difficult to access by land, such as due to traffic or restrictions.

Based on their ability to access locations, which are difficult to access, use of UAVs has begun to span multiple industries, including military, commercial, and personal use. For example, UAV can be used for aerial photography, shipping and delivery, mapping, safety inspections, crop monitoring, cargo transport, law enforcement, and storm tracking, among other uses. The use of UAVs in those industries result in increasing work efficiency and productivity, while decreasing workload and production costs.

Since UAVs are easily able to access views that traditional cameras cannot, UAVs can help increase the effectiveness of domestic surveillance, such as home security. Currently, many companies offer home security monitoring services using sensors or cameras placed on or within a dwelling. However, when cameras are placed on the dwelling or building, the cameras each have a limited range of view and often there are areas within or surrounding the dwelling that are obstructed from the cameras. Further, obtaining an aerial view of a specific property with boundary lines that are not straight and without obtaining views of an adjoining property can be difficult. To prevent obtaining and providing views of property belonging to another owner, any recording views of the property must be removed prior to providing to the owner of the surveilled property. Accordingly, there is a need for obtaining a complete view of a property for surveillance to reduce a number of obstructions in which unauthorized individuals can hide and to reduce a number of cameras or sensors necessary to implement the surveillance. Preferably, the view of the surveilled property will not include any views of another owner's property.

Further, by obtaining aerial views and information for surveillance, UAVs can be used to gather data over large areas of land, such as with burning wildfires. Currently, obtaining information about a forest fire is extremely difficult due to the danger of flying a plane above or otherwise entering the zone of fire. Accordingly, what is needed is a system and method to safely and accurately detect heat blooms and flashpoints for wildfires to mitigate such risk.

Another area in which UAV can be useful in obtaining data is high elevations, which are difficult to reach in person and not always possible to reach by manned aircrafts, such as dense forests. Accordingly, what is needed is a system and method for obtaining data necessary to determine density of snowpack and predict high risk areas.

### SUMMARY

UAVs can be utilized to obtain data in or around areas that are hard to access based on location or that pose a high risk to individuals based on conditions in that area.

A method for performing property surveillance via an unmanned aerial vehicle is provided. Surveillance of one or more properties via an unmanned aerial vehicle is obtained. A geofence that determines boundaries of one of the properties is created using the surveillance. Surveillance outside the geofence for the property is blurred. The blurred surveillance is provided to an owner of that property.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing, by way of example, a system for providing ariel security surveillance.

FIG. 2 is a flow diagram showing, by way of example, a method for land surveillance.

FIG. 3 is a flow diagram showing, by way of example, a method for predicting wildfires.

### DETAILED DESCRIPTION

### Property Surveillance

Property surveillance of homes, commercial businesses, farms or other areas of land, are helpful to prevent damage, property loss, or harm to individuals or animals. Traditional security systems, including manned surveillance, sensors, and cameras are generally unable to cover all areas of a property, resulting in areas where no surveillance is provided. An ariel view of a property provides a greater level of surveillance as the property under surveillance is viewed in full at a single time and property owners are provided with an unrestricted view of their property. Further, security measures can be used to prevent views of other properties owned by other parties.

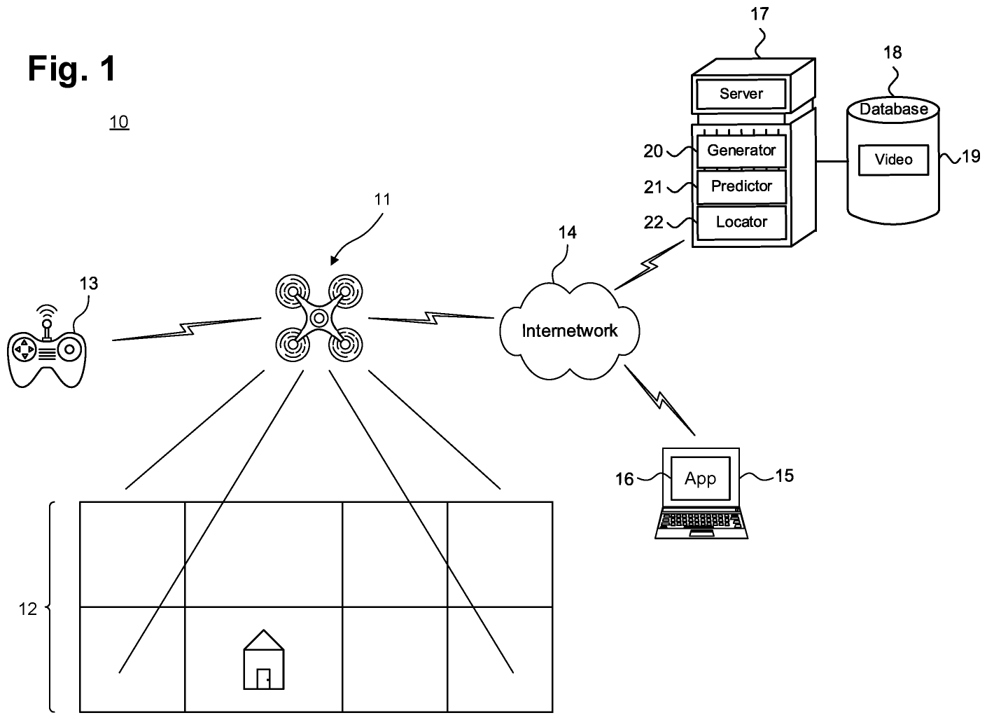

Ariel surveillance can be provided by UAV. FIG. 1 is a block diagram showing, by way of example, a system for providing aerial security surveillance. A UAV, such as a tethered or untethered drone 11, can be deployed over one or more properties 12 for obtaining surveillance. The drone can be an aerostat style drone or a quadcopter, as well as another type of drone. The drone can be controlled by a human via a remote control 13 using radio signals or by a computer application 16 downloaded on a computing device 15 that communicates with the drone 11 via an internetwork 14, such as the Internet or cellular network. When tethered, the drone provides power and data transfer to a ground control system (not shown).

The drone includes a camera (not shown) that captures video files 19 of the properties 12 over a period of time using full motion video or other types of video. The properties surveilled by the drone can be based on a subscription or approval by the property owners. The video files can be transferred via the internetwork 14 to the computing device 15 or to a server 17 remotely located from the computing device 15 for processing and analysis. In one embodiment, the feedback server 14 can be a cloud-based server. A database 18 can be interconnected to the server 17 and configured to store the video files.

The video files 19 can include metadata, such as a location or locations of the camera during recording of the video and, an orientation and distance from the properties for which the video is being recorded. Other types of metadata are possible, such as an identification number of the drone recording the video.

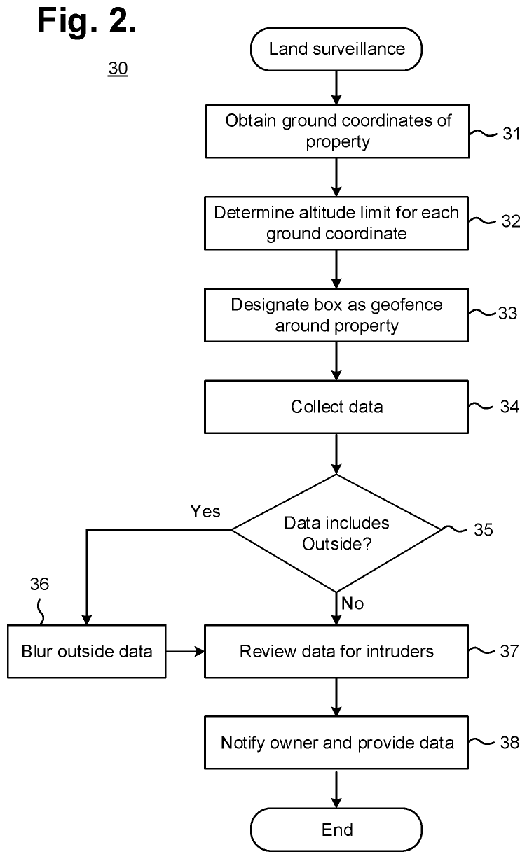

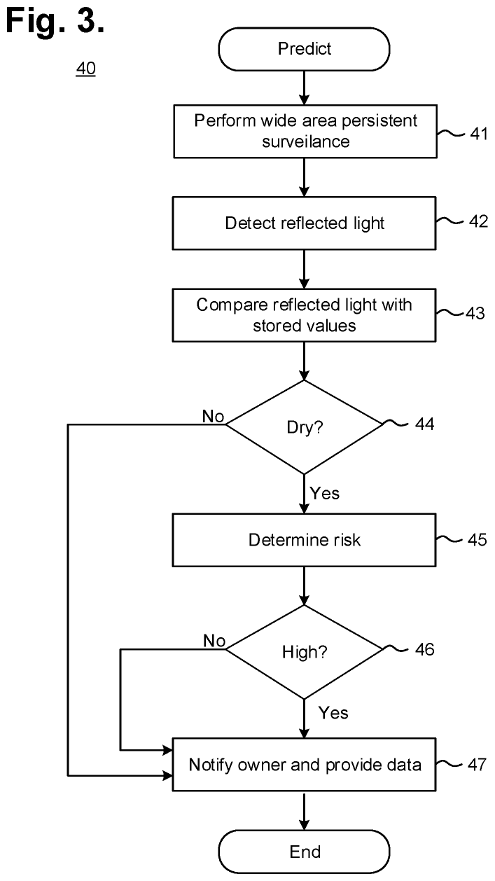

Processing of the video files can include creating geofences to determine the boundaries of each property within the camera's view. Specifically, the server 17 includes a generator 20 to determine geofences for a property to be surveilled to prevent obtaining data for areas outside the property, which is further described in detail below with respect to FIG. 2. A predictor 21 utilizes the video files 19 to predict risk of a fire occurring in a particular location, which is further described in detail with respect to FIG. 3, and a locator 22 can identify locations or areas of possible avalanche by processing data of the video files 19, which is further described below with respect to FIG. 4.

Building geofences for property or land surveillance is useful to prevent obtaining unauthorized video of adjacent properties, while expanding the view of data collected for the property being surveilled. FIG. 2 is a flow diagram showing, by way of example, a method for land surveillance. A set of ground coordinates that represents a geometric footprint on the ground is obtained (step 31) and an altitude limit for each point on the ground is determined (step 32) to make an irregular sided box (step 33), such as based on the property lines, forming the geofence.

A view of the drone can calculate its position relative to the points using GPS and collect data (step 34) within those points of the geofence. Based on the determined geofences, the camera should not collect imagery outside of a defined area of responsibility, such as a particular geofence or geofences, or will group video taken inside designated geofences. However, the collected data is reviewed to determine whether the data includes imagery outside the geofence (step 35). If not, the data is provided for processing, including determining whether any intruders or disturbances are identified (step 37) on the property within the geofence. If so, the owner or other individual associated with the property can be notified (step 38) and the collected imagery is provided (step 38) to the user.

If the video collected by the drone includes views of multiple properties (step 35), blurring of the video (step 36) can also occur to block out images of properties owned by another party, such as outside a particular geofence for the property of which is surveilled for the owner. Blurring properties of other owners helps protect the privacy of those owners while utilizing the unblurred video surveillance for the owner of the property in the unblurred video. Blurring can occur using conventional methods and portions of the video to be blurred can be identified using the geofences or other indicator of property lines.

After blurring, the imagery can be processed (step 37) and provided to a user (step 38). Blockchain can be used to allow access to the blurred imagery for areas outside of an owner's geofenced property boundary. In one example, access is only granted if a majority of property owners with property views in the video consent to the access.

Wide area persistent surveillance and dismounted/ground target indication miniaturized sensors are used to provide point of origin and post event tracking information to law enforcement officers. A point or location and time when a crime was committed can be known and video files provided from the surveillance can be rewound until the crime is located to identify a suspect. The video can then be further rewound to identify a location from which the suspect appeared. Additionally, the video can be fast forwarded after the crime to determine where the suspect was going. Using a picture-in-picture feature of wide area surveillance, the steps of multiple individuals can be retracted.

### Wildfire Prevention and Damage Limitation

Obtaining information to predict wildfires can be difficult to obtain due the large areas of land from which the data must be obtained, including monitoring land that can be difficult to reach due to elevation or remote locations. Further, the data must consistently be obtained to provide an accurate measure of whether a wildfire may occur in a particular location.

UAVs can be helpful in monitoring the land and obtaining data for processing and predicting wildfires. FIG. 3 is a flow diagram showing, by way of example, a method for predicting wildfires. The UAVs, such as drones, can include a sensor that is calibrated to detect light reflected at a wavelength. Specifically, in one embodiment, wide area persistent surveillance can be used in combination with an electro optical and infrared payload to detect heat blooms and likely flashpoints for wildfires across large areas, as well as establish a source of wildfires while concurrently tracking multiple paths through the wide area persistent surveillance. The paths can be tracked manually or automatically.

The wide area persistent surveillance is performed (step 41) and reflected light is detected (step 42). To detect the reflected light, the drone can operate at an altitude which provides a maximum line of sight by the sensor over the target area. The line of sight can be determined similar to the geometry of a triangle. For example, the higher a vertical side, the larger the angle is on a triangle. The range of the sensor can be determined by the size, which is directly proportional to the weight and power requirements. Every sensor can have a range limit.

Particular measures of light reflection can suggest that the environment on the ground below the drone is dry. The reflected light can be compared (step 43) with stored values of reflected light generally indicating dry, wet, or other land conditions. The conditions and associated values can based on types of materials, dimensions of the area, climate, and other factors. For example, a return wavelength of a particular material is subtly different to the return wavelengths from other materials.

Tuning of the sensor can occur at the procurement stage and be refined in the prototyping stage. The dry areas can be represented on a Graphic User Interface as dark spots. However, other types of representations are possible, such as highlighting dry areas or outlining the dry areas.

The dry areas can each represent a potential fire event, such as a presence of a heat bloom, combustible material located within the target area or a heat source. If the area is considered to be dry (step 44), an amount of risk of the dry spot turning into fire event can be determined (step 45) based a severity of the dry area and a likelihood of a fire event according to the equation provided below:

Risk=severity of event×likelihood of event

Specifically, the severity of the dry area can be determined based on how dry the target area measures and a size of the target area. For example, the amount of dryness can be determined by an intensity of a cluster of positive or high risk returns that indicate dry plant matter. The likelihood of a fire event can be determined based on a proximity of the dry area to possible sources of ignition. The sources of ignition can be identified as areas of human habitation or transit or proximity to areas of human habitation or transit. Other methods for determining sources of ignition are possible, such as areas with a high density of objects, such as houses and buildings or trees.

Thresholds for risk can be set manually, automatically, or based on thresholds for other measures. For example, thresholds for risk of death for a particular measure, such as from the Center for Disease Control or other governmental or private entity can be used, as shown in the table below:

| | Risk of Death per annum for population at risk⁵ | | |
|---|---|---|---|
| Boundary | 1^{st} Party | 2^{nd} Party | 3^{rd} Party |
| Intolerable | >1 in 1000 | >1 in 1000 | >1 in 10,000 |
| Tolerable | ≤1 in 1000 | ≤1 in 1000 | ≤1 in 10,000 |
| Broadly | ≤1 in 1,000,000 | ≤1 in 1,000,000 | ≤1 in 1,000,000 |
| Acceptable | | | |

When the risk is determined to be high (step 46) or intolerable, a notification can be transmitted (step 47) to an appropriate person or agency for mitigating the risk. The notification can be provided in the form of an email message, text message, video call, telephone call, or Instant Message. However, other forms of notification are possible.

Further, UAVs can also be used to collect data of an area after a wildfire has occurred.

### Snow Pack Analysis

Measuring a density of snow can help predict areas most affected by avalanches and ensure the safety of users on trails and ski runs. Currently, methods for measuring snow density exist, such as placing stakes in the ground and measuring the height of snowfall over a period of time in different areas. However, measuring snow density over large areas of land can be difficult using the stake method due to the amount of man power needed to place stakes and take measures, some of which can be difficult to obtain based on their location. Utilizing UMVs to obtain data and then analyzing the data to predict avalanche conditions can reduce the amount of manpower required and increase the area in which predications can be made.

An unmanned, passive, persistent surveillance system can provide surveillance, early warning and after action support to the parks service in analyzing depth, quality and conduct of risk assessment. For example, light detection and ranging (Lidar) sensor payload can be used to assess density of snowpack and provide data from prediction of high risk areas, as well as measure snowfall and snow density for commercial applications. Lidar is a ground penetrating radar that identifies a density of material and can be used to model underground cavities, water courses and cave networks. Penetration of the sensor can depend on power, which can be determined by a size of the sensor and done on which the sensor is affixed. A tethered drone can achieve far greater power outputs, so lidar penetrations can be maximized. However, non-tethered drones can also be used in hard to reach areas that are extremely large. The density of the snow pack and the strata will indicate quality, but also risk of avalanche.

Movement can also be tracked and recorded along ski trails to determine population of a particular trail that may or may not be at high risk for avalanche. WAPS is used to monitor a large area of trails and ski runs in combination with ground moving target indication to track movement to map likely areas of high footfall. Further, in combination with the Lidar data, the most at-risk areas for loss of life due to avalanche can be determined. A ground moving target indication is a radar system that can track hundreds and thousands of individual moving objects within a particular area, such as one covered by a payload. The area covered by payload is a specified capability of the sensor and can be defined when a suitable commercially available one has been identified.

As with Lidar, range is maximized by virtue of the tether, so possibly up to 250 sqKm of line of sight can be achieved, but not the reverse side of a mountain, for example. The ground moving target indication identifies movement, attributes the movement to a specific object and tracks that object, sometimes in real time, and in most cases, produces a map of all the tracks of moving objects during its period of collection. The object can be tracked as a function of the payload, while the movement can be attributed to a specific object via one or more algorithms. However, the sensor can differentiate between fixed movement, such as a swaying tree, and linear movement of interest. The map can be produced using an overlay of sensor generated telemetry with a commercial mapping, such as Google Maps, to generate a trace. Areas most at risk of avalanche can be identified as those with the highest amount of linear tracks intersecting those areas.

While the invention has been particularly shown and described as referenced to the embodiments thereof, those skilled in the art will understand that the foregoing and other changes in form and detail may be made therein without departing from the spirit and scope of the invention.

What is claimed is:

1. A method for performing property surveillance via an unmanned aerial vehicle, comprising:
obtaining surveillance of one or more properties via an unmanned aerial vehicle;
processing the obtained surveillance comprising creating a geofence that determines boundaries of one of the properties;
blurring the obtained surveillance outside the geofence for the property; and
providing the surveillance with the blurred surveillance to an owner of that property.

2. A method according to claim 1, wherein the unmanned aerial vehicle is tethered or untethered.

3. A method according to claim 2, wherein the unmanned aerial vehicle comprises an aerostat drone or quadcopter.

4. A method according to claim 1, wherein the surveillance comprises video files.

5. A method according to claim 1, wherein the properties are identified for surveillance based on approval by owners of the properties or based on a subscription.

6. A method according to claim 1, wherein the geofence comprises a set of ground coordinates that represent a geometric footprint on the ground and an altitude limit for each point on the ground.

7. A method according to claim 1, wherein the surveillance comprises image data and coordinates.

8. A method according to claim 1, further comprising:
analyzing the surveillance; and
identifying an intruder.

9. A method according to claim 1, further comprising:
notifying a user of the property of the identified intruder.

10. A method for performing property surveillance via an unmanned aerial vehicle, comprising:
obtaining surveillance of one or more properties via an unmanned aerial vehicle;
processing the obtained surveillance comprising creating geofences which each determine boundaries of one of the properties; and
for one property, obtaining further surveillance based on the geofence for that property.

11. A method for predicting wildfires, comprising:
determining light reflected at a wavelength via an unmanned aerial vehicle to determine a heat bloom for a wildfire as a dry area;
representing the dry area on a graphic user interface via an indicator;
determining an amount of risk of the dry spot; and
when the amount of risk is determined to be high, sending a notification of the risk.

12. A method for performing snow pack analysis, comprising:
performing light detection to assess density of a snow pack via a lidar sensor on an unmanned aerial vehicle;
determining a population of an area;
tracking one or more ground moving targets in the area;
generating a map comprising an overlay of the tracked ground moving targets on a map of the area; and
determining the area as high risk for avalanche when the area has a high amount of linear tracks intersecting the area.
